(19) United States
(12) Patent Application Publication
(10) Pub. No.: US 2013/0188289 A1
(43) Pub. Date: Jul. 25, 2013

(54) PROTECTION CIRCUIT

(71) Applicants: Katsuhiko Misawa, Tokyo (JP); Masafumi Yoshida, Tokyo (JP); Takuya Taniguchi, Tokyo (JP); Ko Takemura, Tokyo (JP)

(72) Inventors: Katsuhiko Misawa, Tokyo (JP); Masafumi Yoshida, Tokyo (JP); Takuya Taniguchi, Tokyo (JP); Ko Takemura, Tokyo (JP)

(73) Assignee: THINE ELECTRONICS, INC., Chiyoda-ku, Tokyo (JP)

(21) Appl. No.: 13/877,423

(22) PCT Filed: Aug. 31, 2011
(86) PCT No.: PCT/JP2011/069821

§ 371 Date: Apr. 2, 2013

(30) Foreign Application Priority Data
Oct. 5, 2010 (JP) 2010-225909

(51) Int. Cl. H02H 9/02

(52) U.S. Cl. CPC H02H 9/02
USPC 361/93.9

(57) ABSTRACT

A protection circuit 2 of a first embodiment comprises a resistance-variable switch 10, an overcurrent detection unit 20, a control voltage application unit 30, a capacity unit 40, a control terminal voltage change unit 50, and an outer terminal 11. The resistance-variable switch 10 has a control terminal 10a, a first terminal 10b, and a second terminal 10c. The control terminal voltage change unit 50 includes a switch 51 and a resistor 52 which are provided in series between the control terminal 10a of the resistance-variable switch 10 and a reference potential terminal.

### TECHNICAL FIELD

The present invention relates to a protection circuit.

### BACKGROUND ART

Short-circuiting in an electric circuit such as a semiconductor circuit imparts an excessive current to a device and the like connected to the electric circuit. In this case, a current exceeding the absolute maximum rating may flow through the device, thereby destroying it. For preventing this, protection circuits for detecting an excessive current and lowering the current flowing through the device have been known (Patent Literatures 1 and 2). However, rapidly lowering the current flowing through the device may allow a parasitic inductance to generate a counter-electromotive force, thereby destroying the device.

Aiming to overcome this problem, Patent Literature 1 discloses a short-circuit protection circuit in which a plurality of current detection resistances and a plurality of protection semiconductor elements are connected to a semiconductor device. When a circuit to which the semiconductor device is connected is short-circuited, this short-circuit protection circuit sequentially energizes a plurality of protection semiconductor elements, so that the current flowing through the device is lowered stepwise. This intends to avoid the device from being destroyed by the counter-electromotive force.

### CITATION LIST

### Patent Literature

Patent Literature 1: Japanese Patent Application Laid-Open No. 2000-323974
Patent Literature 2: Japanese Patent Application Laid-Open No. 2002-353795

### SUMMARY OF INVENTION

### Technical Problem

While the short-circuit protection circuit of Patent Literature 1 lowers stepwise the current flowing through the device by sequentially energizing a plurality of protection semiconductor elements, each protection semiconductor element is energized for an instant, so that the current changes drastically anyway. As a result, a counter-electromotive force for canceling the drastic change in current occurs, whereby the problem of the semiconductor device being destroyed by the counter-electromotive force still remains. In LED displays, LED backlights, and amusement devices (game machines), for example, LEDs are arranged over a wide area of the devices, so that there is a longer wiring distance between an LED serving as a load and a drive device for driving it, which increases the parasitic inductance of the wiring, whereby the above-mentioned problem becomes more remarkable.

It is therefore an object of the present invention to provide a protection circuit which can more effectively inhibit counter-electromotive voltages from occurring and prevent devices from being destroyed by excessive voltages.

### Solution to Problem

The protection circuit in accordance with the present invention comprises a resistance-variable switch having a control terminal and first and second terminals, the first and second terminals yielding therebetween a resistance value continuously monotonously changing with respect to a control voltage applied to the control terminal within the range from V₁ to V₂, the resistance value being greater when the control voltage is V₂ than when V₁; a capacity unit having one end connected to the control terminal of the resistance-variable switch; an overcurrent detection unit for outputting an overcurrent detection signal turning from an insignificant value to a significant value when a current flowing between the first and second terminals of the resistance-variable switch is greater than a predetermined threshold; a control voltage application unit for outputting and applying a control voltage value from an output end to the control terminal of the resistance-variable switch when the overcurrent detection signal is the insignificant value and placing the output terminal into a high impedance state when the overcurrent detection signal is the significant value; and a control terminal voltage change unit for continuously changing the voltage value at the control terminal of the resistance-variable switch from V₁ to V₂ by discharging or charging the capacity unit when the overcurrent detection signal is the significant value.

When the overcurrent detection signal becomes a significant value, the protection circuit continuously changes the control voltage value applied to the control terminal of the resistance-variable switch from V₁ to V₂ by discharging or charging the capacity unit. This continuously increases the resistance value between the first and second terminals of the resistance-variable switch, thereby continuously decreasing the current flowing therebetween. Hence, a protection circuit which can more effectively prevent devices from being destroyed than when instantaneously turning off the control voltage applied to the control terminal of the resistance-variable switch can be provided. Examples of the resistance-variable switch include MOS transistors and bipolar transistors. When the resistance-variable switch is a MOS transistor, the control terminal is the gate terminal, one of the first and second terminals is the source terminal, and the other is the drain terminal. When the resistance-variable switch is a bipolar transistor, the control terminal is the base terminal, one of the first and second terminals is the collector terminal, and the other is the emitter terminal.

The resistance value between the first and second terminals monotonously continuously changes with respect to the control voltage value within the range from V₁ to V₂ applied to the control terminal of the resistance-variable switch, so that the resistance value R₂ obtained at the control voltage V₂ is greater than the resistance value R₁ obtained at the control voltage V₁. That is, the resistance value between the first and second terminals monotonously increases as the control voltage value continuously changes from V₁ to V₂. The magnitude relationship between the control voltage values V₁ and V₂ is determined by a characteristic of the resistance-variable switch employed. Examples of the capacity unit include an element intentionally constituted by a capacitor or the like and a parasitic capacity. When the resistance-variable switch is a MOS transistor, for example, its gate capacitance may serve as the capacity unit.

More specifically, the control terminal voltage change unit preferably includes a switch and a resistor which are provided in series between the control terminal of the resistance-variable switch and a reference potential terminal and turns the switch on when the overcurrent detection signal is the significant value, so as to change the voltage value at the control terminal of the resistance-variable switch continuously at a speed corresponding to a resistance value of the resistor and a capacity value of the capacity unit.

More specifically, the control terminal voltage change unit preferably includes a switch provided between the control terminal of the resistance-variable switch and a reference potential terminal and turns the switch on when the overcurrent detection signal is the significant value, so as to change the voltage value at the control terminal of the resistance-variable switch continuously at a speed corresponding to an ON-resistance value of the switch and a capacity value of the capacity unit.

More specifically, the control terminal voltage change unit preferably includes a current source provided between the control terminal of the resistance-variable switch and a reference potential terminal and starts operating the current source when the overcurrent detection signal is the significant value, so as to change the voltage value at the control terminal of the resistance-variable switch continuously at a speed corresponding to a current value of the current source and a capacity value of the capacity unit.

### Advantageous Effects of Invention

The present invention can provide a protection circuit which can more effectively inhibit counter-electromotive voltages from occurring and prevent devices from being destroyed by excessive voltages.

### BRIEF DESCRIPTION OF DRAWINGS

FIG. 1 is a diagram illustrating the structure of a protection circuit 1 of a comparative example;

FIG. 2 is a diagram for explaining waveforms of signal, current, or voltage at nodes in the protection circuit 1 of the comparative example;

FIG. 3 is a diagram for explaining waveforms of signal, current, or voltage at nodes in the protection circuit 1 of the comparative example in another mode;

FIG. 4 is a diagram illustrating the structure of a protection circuit 2 in accordance with a first embodiment;

FIG. 5 is a diagram for explaining waveforms of signal, current, or voltage at nodes in the protection circuit 2 of the first embodiment in a first operation mode;

FIG. 6 is a diagram for explaining waveforms of signal, current, or voltage at nodes in the protection circuit 2 of the first embodiment in a second operation mode;

FIG. 7 is a diagram illustrating the structure of a protection circuit 3 in accordance with a second embodiment; and

FIG. 8 is a diagram illustrating the structure of a protection circuit 4 in accordance with a third embodiment.

### DESCRIPTION OF EMBODIMENTS

In the following, preferred embodiments of the present invention will be explained in detail with reference to the accompanying drawings. In the explanation of the drawings, the same constituents will be referred to with the same signs, while omitting their overlapping descriptions. A comparative example will be explained first before the embodiments.

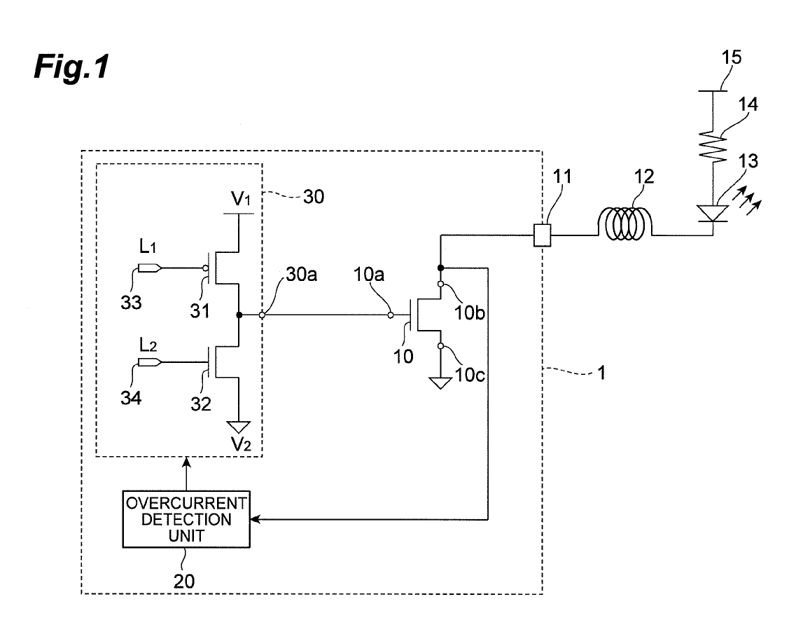

FIG. 1 is a diagram illustrating the structure of a protection circuit 1 of the comparative example. The protection circuit 1 comprises a resistance-variable switch 10, an overcurrent detection unit 20, a control voltage application unit 30, and an outer terminal 11. FIG. 1 also depicts a line 12 connected to the outer terminal 11, an LED 13, a resistor 14, and a power supply 15 for providing a constant voltage V_{CC}.

The resistance-variable switch 10 has a control terminal 10a, a first terminal 10b, and a second terminal 10c. The control terminal 10a of the resistance-variable switch 10 is connected to the control voltage application unit 30, the first terminal 10b is connected to the LED 13 through the outer terminal 11 and line 12, and the second terminal 10c is grounded. The current value flowing between the first and second terminals 10b, 10c of the resistance-variable switch 10 is determined by the resistance value of the resistor 14, the forward voltage of the LED 13, the ON-resistance value of the resistance-variable switch 10, and the like. A specific example of the resistance-variable switch 10 is an NMOS transistor. In this case, the first terminal 10b, second terminal 10c, and control terminal 10a correspond to drain, source, and gate terminals, respectively. The following explanation will assume the resistance-variable switch 10 to be an NMOS transistor.

The overcurrent detection unit 20 detects whether or not the current flowing between the first and second terminals 10b, 10c of the resistance-variable switch 10 is an overcurrent. The overcurrent detection unit 20 outputs an overcurrent detection signal which turns from an insignificant value to a significant value when the current flowing between the first and second terminals 10b, 10c of the resistance-variable switch 10 exceeds a predetermined threshold Iₜₕ. When the current is smaller than the predetermined threshold Iₜₕ, on the other hand, the overcurrent detection signal is fed as the insignificant value to the control voltage application unit 30. The overcurrent detection signal is a digital signal, which represents significant and insignificant values when at high and low levels, respectively, for example.

According to the overcurrent detection signal fed from the overcurrent detection unit 20, the control voltage application unit 30 applies a control voltage to the control terminal 10a of the resistance-variable switch 10. When the overcurrent detection signal fed from the overcurrent detection unit 20 is the insignificant value, the control voltage application unit 30 issues a control voltage value from an output terminal 30a, so as to apply a first reference potential V₁ or second reference potential V₂, which will be explained later, to the control terminal 10a of the resistance-variable switch 10. When the first reference potential V₁ is applied to the control terminal 10a, a current flows between the first and second terminals 10b, 10c, whereby the LED 13 emits light. When the overcurrent detection signal fed from the overcurrent detection unit 20 turns into the significant value, on the other hand, the control voltage application unit 30 applies the control voltage V₂ to the control terminal 10a of the resistance-variable switch 10. When the second reference potential is applied to the control terminal 10a, the resistance value between the first and second terminals 10b, 10c becomes greater, so that no current flows substantially or at all between the first and second terminals 10b, 10c, whereby the LED 13 does not emit light.

The control voltage value applied to the control terminal 10a of the resistance-variable switch 10 by the control voltage application unit 30 will now be explained. For example, the control voltage application unit 30 is constructed so as to include a PMOS transistor 31, an NMOS transistor 32, a first input terminal 33 for receiving a first input signal L₁ to be fed to the gate terminal of the PMOS transistor 31, and a second input terminal 34 for receiving a second input signal L₂ to be fed to the gate terminal of the NMOS transistor 32. The PMOS transistor 31 has a source terminal for receiving the first reference potential V₁, the gate terminal connected to the first input terminal 33, and a drain terminal connected to the control terminal 10a of the resistance-variable switch 10. The NMOS transistor 32 has a source terminal for receiving the second reference potential V₂, the gate terminal connected to the second input terminal 34, and a drain terminal connected to the control terminal 10a of the resistance-variable switch 10.

The first input terminal 33 receives the first input signal L₁. The second input terminal 34 receives the second input signal L₂. When both of the first and second input signals L₁, L₂ fed to the first and second input terminals 33, 34 are at low levels, the PMOS transistor 31 and NMOS transistor 32 are turned on and off, respectively, whereby the first reference potential V₁ is applied from the PMOS transistor 31 to the control terminal 10a of the resistance-variable switch 10. When both of the first and second input signals L₁, L₂ fed to the first and second input terminals 33, 34 are at high levels, on the other hand, the PMOS transistor 31 and NMOS transistor 32 are turned off and on, respectively, whereby the second reference potential V₂ is applied from the NMOS transistor 32 to the control terminal 10a of the resistance-variable switch 10. During a (normal operation) period in which the current flowing between the first and second terminals 10b, 10c of the resistance-variable switch 10 is not greater than the predetermined threshold Iₜₕ, so that the overcurrent detection signal issued from the overcurrent detection unit 20 is the insignificant value, the control voltage application unit 30 applies the control voltage V₁ or V₂ to the control terminal 10a of the resistance-variable switch 10.

The LED 13 has an anode connected to the power supply 15 through the resistor 14 and a cathode connected to the protection circuit 11 through the line 12 and outer terminal 11. When the control voltage application unit 30 applies the first reference potential V₁ to the control terminal 10a of the resistance-variable switch 10, the resistance value between the first and second terminals 10b, 10c becomes smaller, so that the current flowing between the first and second terminals 10b, 10c increases, whereby the LED 13 emits light. When the control voltage application unit 30 applies the second reference potential V₂ to the control terminal 10a of the resistance-variable switch 10, the resistance value between the first and second terminals 10b, 10c becomes greater, so that no current flows substantially or at all between the first and second terminals 10b, 10c, whereby the LED 13 does not emit light.

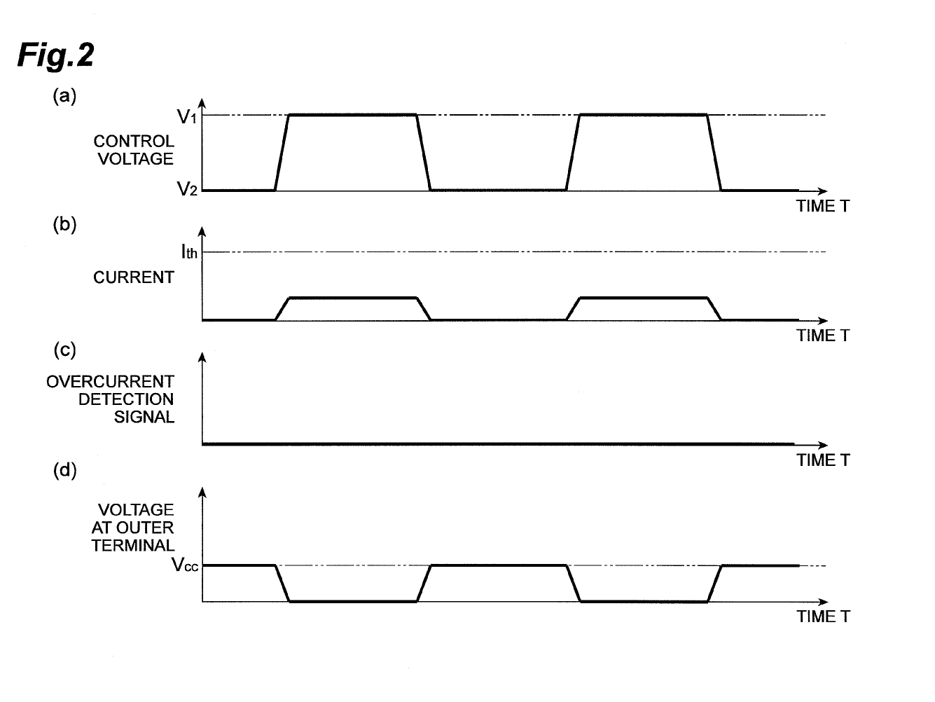

FIG. 2 is a diagram for explaining waveforms of signal, current, or voltage at nodes in the protection circuit 1 of the comparative example. In this diagram, (a), (b), (c), and (d) illustrate waveforms of the control voltage value applied from the control voltage application unit 30 to the control terminal 10a of the resistance-variable switch 10, the current flowing through the resistance-variable switch 10, the overcurrent detection signal issued from the overcurrent detection unit 20, and the voltage at the outer terminal 11, respectively. Here, FIG. 2 is a diagram for explaining the waveforms during a period when the overcurrent detection signal fed to the control voltage application unit 30 is the insignificant value, i.e., in the normal operation in which the current flowing between the first and second terminals 10b, 10c of the resistance-variable switch 10 is not greater than the predetermined threshold Iₜₕ according to the overcurrent detection unit 20.

As illustrated in FIG. 2(a), the control voltage application unit 30 applies the control voltage V₁ or V₂ to the control terminal 10a of the resistance-variable switch 10. The control voltage applied to the control terminal 10a changes the current flowing between the first and second terminals 10b, 10c of the resistance-variable switch 10. The current value increases and decreases when the control voltages V₁ and V₂ are applied to the control terminal 10a, respectively ((b) in the diagram). The control voltage applied to the control terminal 10a similarly changes the voltage at the outer terminal 11. When the control voltage V₁ is applied to the control terminal 10a, the voltage at the outer terminal 11 attains a value near the ground potential. When the control voltage V₂ is applied to the control terminal 10a, the voltage at the outer terminal 11 attains a value near V_{CC} ((d) in the diagram). As mentioned above, the overcurrent detection unit 20 issues the overcurrent detection signal at the insignificant value ((c) in the diagram).

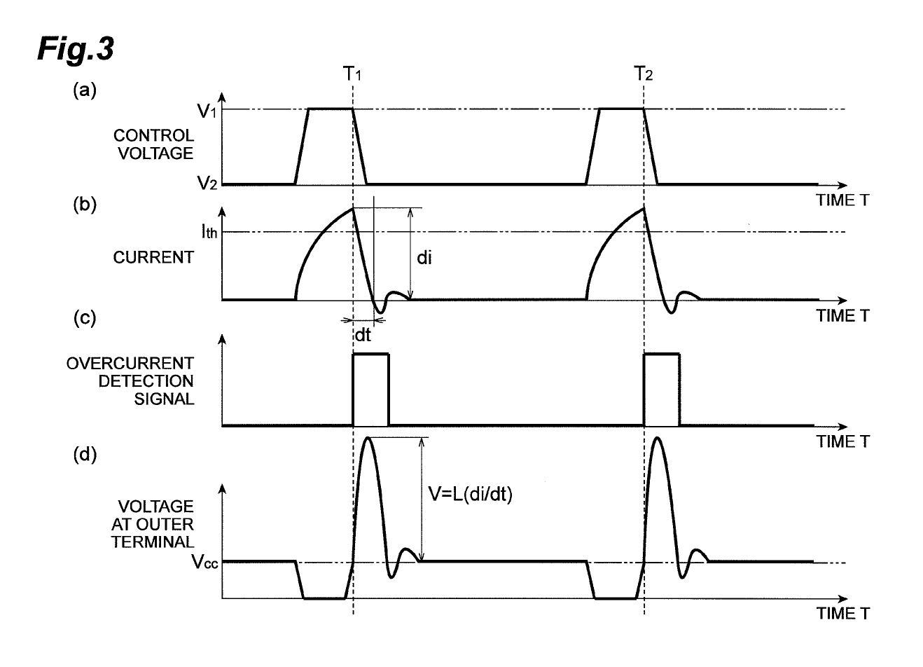

FIG. 3 is a diagram for explaining waveforms of signal, current, or voltage at individual nodes in the protection circuit 1 of the comparative example in another operation mode. That is, this diagram explains the waveforms in a case where the current flowing between the first and second terminals 10b, 10c of the resistance-variable switch 10 is greater than the predetermined threshold Iₜₕ, so that the overcurrent detection signal issued from the overcurrent detection unit 20 turns from the insignificant value to the significant value. In this diagram, (a), (b), (c), and (d) illustrate waveforms of the control voltage value applied from the control voltage application unit 30 to the control terminal 10a of the resistance-variable switch 10, the current flowing through the resistance-variable switch 10, the overcurrent detection signal issued from the overcurrent detection unit 20, and the voltage at the outer terminal 11, respectively. When short-circuiting occurs between the cathode of the LED 13 and the power supply 15, the current flowing between the first and second terminals 10b, 10c of the resistance-variable switch 10 exceeds the predetermined threshold Iₜₕ. After the current exceeds the predetermined threshold Iₜₕ, the fact that the current has exceeded the predetermined threshold Iₜₕ is detected by the overcurrent detection unit 20, whereby the overcurrent detection signal turns from the insignificant value to the significant value (at time T₁ in (c) of the diagram). When the overcurrent detection signal turns from the insignificant value to the significant value, the control voltage V₂ is applied to the control terminal 10a of the resistance-variable switch 10 ((a) in the diagram). Along with this, the current flowing between the first and second terminals 10b, 10c decreases drastically ((b) in the diagram). At that instant, a large counter-electromotive voltage V=L(di/dt) is generated by an inductance component of the line 12 ((d) in the diagram) and may destroy the protection circuit 1, the resistance-variable switch 10, or devices (not depicted) electrically connected to the outer terminal 11.

The short-circuit protection circuit disclosed in Patent Literature 1 lowers the current I flowing through the semiconductor device (MOS transistor) stepwise but drastically anyway. Therefore, the counter-electromotive voltage V may occur and destroy the protection circuit 1 or resistance-variable switch 10 as in the comparative example. The protection circuit of an embodiment which will be explained in the following, on the other hand, continuously changes the control voltage value applied to the control terminal 10a of the resistance-variable switch 10 from V₁ to V₂ when the overcurrent detection signal turns from the insignificant value to the significant value. This continuously increases the resistance value between the first and second terminals 10b, 10c of the resistance-variable switch 10, thereby continuously decreasing the current flowing therebetween. Hence, a protection circuit 2 which can more effectively inhibit devices from being destroyed than does the short-circuit protection circuit disclosed in Patent Literature 1 can be provided.

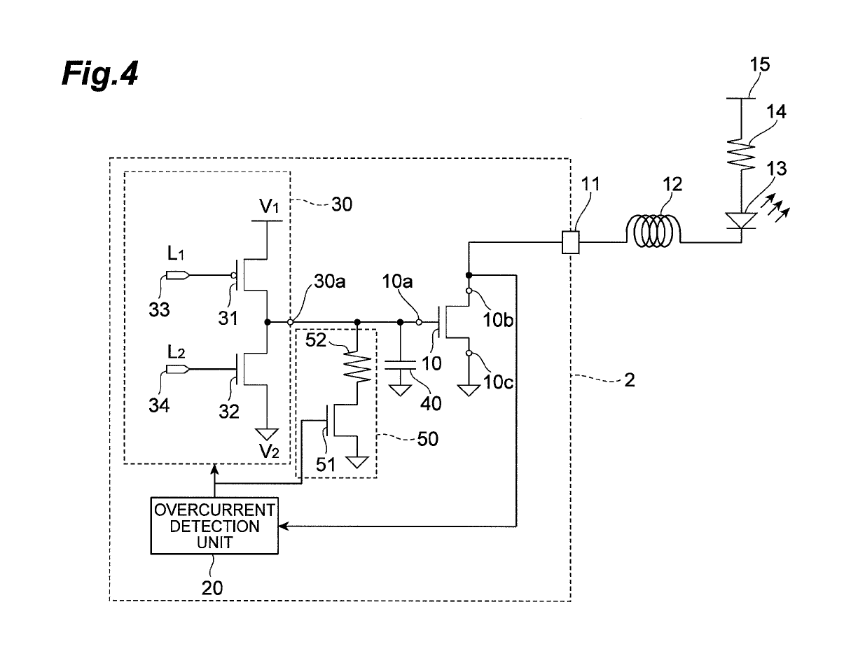

FIG. 4 is a diagram illustrating the structure of the protection circuit 2 in accordance with the first embodiment. The protection circuit 2 in accordance with the first embodiment illustrated in FIG. 4 differs from the protection circuit 1 of the comparative example illustrated in FIG. 1 in functions of the resistance-variable switch 10, overcurrent detection unit 20, and control voltage application unit 30 and in that it further comprises a capacity unit 40 having one end connected to the control terminal 10a of the resistance-variable switch 10 and a control terminal voltage change unit 50 provided between the control terminal 10a of the resistance-variable switch 10 and a reference potential terminal. The other structure (outer terminal 11) of the protection circuit 2 is the same as that of the protection circuit 1 of the comparative example. In the following, the protection circuit 2 of this embodiment will be explained mainly in terms of differences from the comparative example.

The resistance-variable switch 10 has the control terminal 10a, first terminal 10b, and second terminal 10c. The control terminal 10a is connected to the control voltage application unit 30, the first terminal 10b is connected to the line 12 and the like through the outer terminal 11, and the second terminal 10c is grounded. When the control voltage application unit 30 applies the control voltage value V₁ to V₂ to the control terminal 10a, the resistance-variable switch 10 changes the resistance value between the first and second terminals 10b, 10c according to the control voltage value. When the control terminal voltage change unit 50, which will be explained later, continuously changes the control voltage value at the control terminal 10a of the resistance-variable switch 10 from V₁ to V₂, the resistance value between the first and second terminals 10b, 10c changes continuously. As a result, the resistance-variable switch 10 continuously changes the current flowing between the first and second terminals 10b, 10c. A specific example of the resistance-variable switch 10 is an NMOS transistor, while the first terminal 10b, second terminal 10c, and control terminal 10a correspond to drain, source, and gate terminals, respectively, in this case. The following explanation will assume the resistance-variable switch 10 to be an NMOS transistor.

The overcurrent detection unit 20 has the same structure as that of the comparative example but differs therefrom in the output destination of the overcurrent detection signal. That is, the overcurrent detection unit 20 outputs the overcurrent detection signal not only to the control voltage application unit 30, but also to the control terminal voltage change unit 50, which will be explained later.

The overcurrent application unit 30 applies the control voltage value V₁ to V₂ to the control terminal 10a of the resistance-variable switch 10 according to the overcurrent detection signal fed from the overcurrent detection unit 20. When the overcurrent detection signal fed from the overcurrent detection unit 20 is an insignificant value, the control voltage application unit 30 issues a control voltage value from the output terminal 30a, so as to apply the control voltage V₁ to V₂ to the control terminal 10a of the resistance-variable switch 10. When the overcurrent detection signal fed from the overcurrent detection unit 20 turns from the insignificant value to a significant value, on the other hand, the control voltage application unit 30 places the output terminal 30a into a high impedance state.

The capacity unit 40 is charged/discharged with a charging/discharging amount corresponding to the current drive capability of the control voltage application unit 30, whereby the voltage of the control terminal 10a changes. The capacity unit 40 is also charged/discharged by the control terminal voltage change unit 50, which will be explained later, when the output terminal 30a of the control voltage application unit 30 attains the high impedance state. Examples of the capacity unit 40 include an element intentionally constituted by a capacitor or the like and a parasitic capacity. When the resistance-variable switch 10 is a MOS transistor, for example, its gate capacitance may serve as the capacity unit.

The control terminal voltage change unit 50 includes a switch 51 and a resistor 52 which are arranged in series between the control terminal 10a of the resistance-variable switch 10 and a reference potential terminal. A specific example of the switch is an NMOS transistor, which has a gate terminal connected to the overcurrent detection unit 20, a drain terminal connected to the resistor 52, and a source terminal connected (grounded) to the reference potential terminal. The switch 51 is under control of the overcurrent detection signal fed from the overcurrent detection unit 20, so as to turn on when the overcurrent detection signal fed from the overcurrent detection unit 20 changes from the insignificant value to the significant value and turn off when the overcurrent detection signal fed from the overcurrent detection unit 20 becomes the insignificant value. The resistor 52 has one end connected to the control terminal 10a of the resistance-variable switch 10 and the other end connected to the switch 51.

When the overcurrent detection signal fed from the overcurrent detection unit 20 changes from the insignificant value to the significant value, the control terminal voltage change unit 50 turns the switch 51 on. When the switch 51 is turned on, the control terminal voltage change unit 50 charges/discharges the capacity unit 40 through the resistor 52, so as to change the voltage value applied to the control terminal 10a of the resistance-variable switch 10 continuously from V₁ to V₂. This continuously increases the resistance value between the first and second terminals 10b, 10c of the resistance-variable switch 10, thereby continuously decreasing the current flowing therebetween.

Waveforms of signal, current, or voltage at nodes in the protection circuit 2 of the first embodiment will now be explained separately in first and second operation modes. The control terminal voltage change unit 50 starts continuously changing the voltage value at the control terminal 10a of the resistance-variable switch 10 from V₁ to V₂ when the overcurrent detection signal fed from the overcurrent detection unit 20 turns from the insignificant value to the significant value in both of the first and second operation modes. In the first operation mode, the significant value of the overcurrent detection signal is held even when the current flowing between the first and second terminals 10b, 10c of the resistance-variable switch 10 is at the predetermined threshold Iₜ, or below. As a result, the voltage value at the control terminal 10a of the resistance-variable switch 10 changes continuously from V₁ to V₂. In the second operation mode, on the other hand, the overcurrent detection signal returns from the significant value to the insignificant value when the current flowing between the first and second terminals 10b, 10c of the resistance-variable switch 10 decreases to the predetermined threshold Iₜₕ or below. As a result, when the control voltage application unit 30 applies the control voltage V₂ to the control terminal 10a of the resistance-variable switch 10 while the voltage value at the control terminal 10a continuously changes from V₁ to V₂, the voltage value decreases drastically.

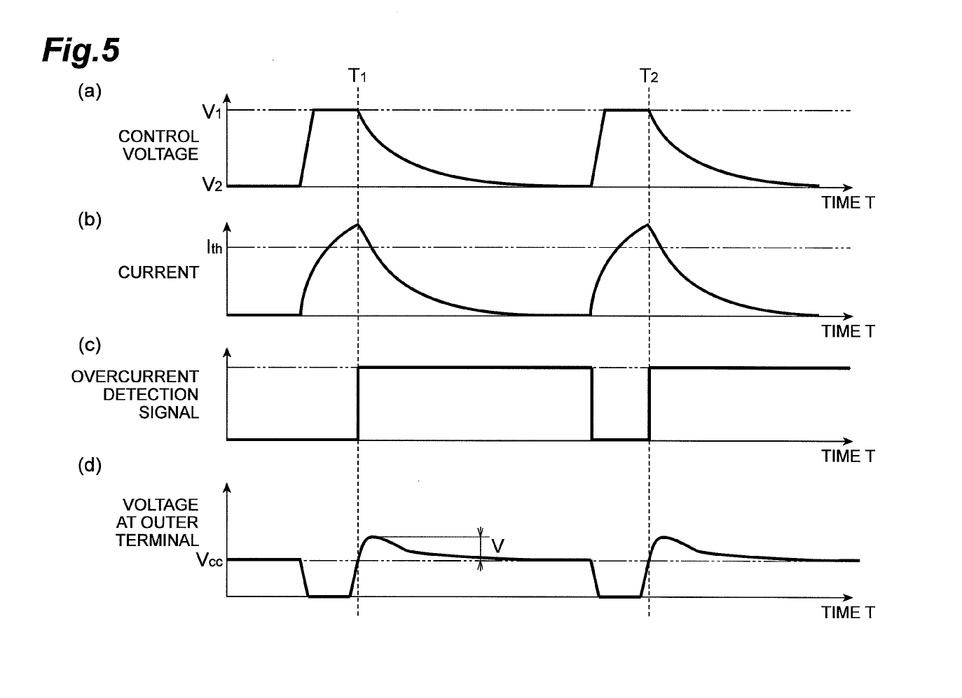

FIG. 5 is a diagram for explaining waveforms of signal, current, or voltage at individual nodes in the protection circuit 2 of the first embodiment in the first operation mode. In this diagram, (a), (b), (c), and (d) illustrate waveforms of the control voltage value applied from the control voltage application unit 30 to the control terminal 10a of the resistance-variable switch 10, the current flowing through the resistance-variable switch 10, the overcurrent detection signal issued from the overcurrent detection unit 20, and the voltage at the outer terminal 11, respectively. When short-circuiting occurs between the cathode of the LED 13 and the power supply 15 while the control signal V₁ is applied to the control terminal 10a of the resistance-variable switch 10, the current flowing between the first and second terminals 10b, 10c of the resistance-variable switch 10 exceeds the predetermined threshold Iₜₕ. After the current exceeds the predetermined threshold 4, the fact that the current has exceeded the predetermined threshold Iₜₕ is detected by the overcurrent detection unit 20, whereby the overcurrent detection signal turns from the insignificant value to the significant value (at time T₁ in (c) of the diagram). When the overcurrent detection signal changes from the insignificant value to the significant value, the output terminal 30a of the control voltage application unit 30 attains the high impedance state, while the switch 51 of the control terminal voltage change unit 50 is turned on. When the switch 51 is turned on, the capacity unit 40 is charged/discharged through the resistor 52, so that the voltage value at the control terminal 10a of the resistance-variable switch 10 continuously changes from V₁ to V₂ ((a) in the diagram). Along with this, the current flowing between the first and second terminals 10b, 10c decreases continuously ((b) in the diagram). As a result, inductance components of the line 12 are hard to generate a large counter-electromotive voltage V ((d) in the diagram), thereby inhibiting the protection circuit 2, the resistance-variable switch 10, or devices (not depicted) electrically connected to the outer terminal 11 from being destroyed. The change in voltage value from V₁ to V₂ occurs at a speed corresponding to the resistance value of the resistor 52 and the capacity value of the capacity unit 40.

In the first operation mode, the significant value of the overcurrent detection signal is held even when the current flowing between the first and second terminals 10b, 10c of the resistance-variable switch 10 is at the predetermined threshold Iₜ, or below as mentioned above (FIG. 5(c)). The holding of the significant value of the overcurrent detection signal is achieved by a storage unit (not depicted) in the overcurrent detection unit 20, for example. If the overcurrent detection signal attains the significant value even for an instant in this case, the overcurrent detection unit 20 will hold the significant value of the overcurrent detection signal even after the current flowing between the first and second terminals 10b, 10c of the resistance-variable switch 10 is at the predetermined threshold Iₜ, or below. Thereafter, a signal for releasing the significant value is fed from an undepicted control unit to the overcurrent detection unit 20, whereby the holding of the significant value is released. After the overcurrent detection signal is released from the significant value and returned to the insignificant value, the control voltage application unit 30 applies the control voltage V₁ again to the voltage value at the control terminal 10a. Then, when the current flowing between the first and second terminals 10b, 10c of the resistance-variable switch 10 exceeds the predetermined threshold Iₜₕ, the overcurrent detection signal turns from the insignificant value to the significant value again (at time T₂), so that the control terminal voltage change unit 50 charges/discharges the capacity unit 40, whereby the voltage value applied to the control terminal 10a of the variable switch 10 continuously changes from V₁ to V₂. The protection circuit 2 repeats this action until there is no short-circuiting.

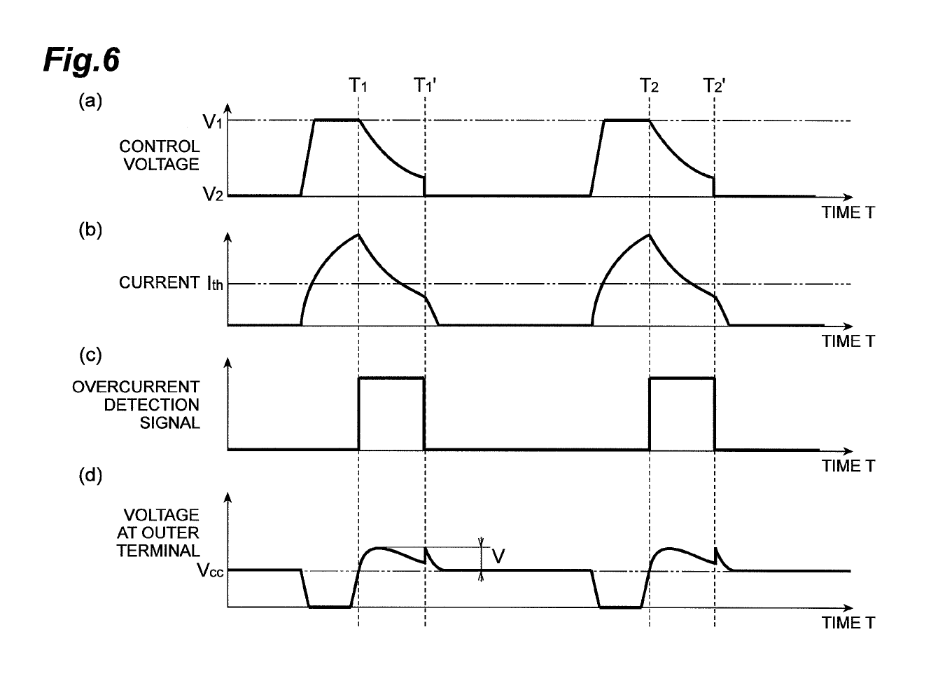

FIG. 6 is a diagram for explaining waveforms of signal, current, or voltage at individual nodes in the protection circuit 2 of the first embodiment in the second operation mode. In this diagram, (a), (b), (c), and (d) illustrate waveforms of the control voltage value applied from the control voltage application unit 30 to the control terminal 10a of the resistance-variable switch 10, the current flowing through the resistance-variable switch 10, the overcurrent detection signal issued from the overcurrent detection unit 20, and the voltage at the outer terminal 11, respectively. First, when the overcurrent detection signal changes from the insignificant value to the significant value (at time T₁ in (c) of the diagram) in the second operation mode, the output terminal 30a of the control voltage application unit 30 attains the high impedance state while the switch 51 of the control terminal voltage change unit 50 is turned on as in the first operation mode. This allows the control terminal voltage change unit 50 to start changing the voltage value at the control terminal 10a of the resistance-variable switch 10 continuously from V₁ to V₂ ((a) in the diagram). When the current flowing between the first and second terminals 10b, 10c of the resistance-variable switch 10 decreases to the predetermined threshold Iₜ, or below while the voltage value at the control terminal 10a continuously changes from V₁ to V₂ here, the overcurrent detection signal returns from the significant value to the insignificant value (at time T₁′ in FIG. 6(c)). When the overcurrent detection signal returns to the insignificant value, so as to allow the control voltage application unit 30 to apply the control voltage V₂ to the voltage at the control terminal 10a, the voltage value decreases drastically. As a consequence, the current flowing between the first and second terminals 10b, 10c decreases drastically ((b) in the diagram). Since this change in current falls within the range of the predetermined threshold Iₜₕ, inductance components of the line 12 are hard to generate a large counter-electromotive voltage V ((d) in the diagram), thereby inhibiting the protection circuit 2, the resistance-variable switch 10, or devices (not depicted) electrically connected to the outer terminal 11 from being destroyed.

After the overcurrent detection signal returns to the insignificant value, the control voltage application unit 30 applies the control voltage V₁ again to the voltage at the control terminal 10a. Then, when the current flowing between the first and second terminals 10b, 10c exceeds the predetermined threshold Iₜₕ, the overcurrent detection signal turns from the insignificant value to the significant value (at time T₂), so that the control terminal voltage change unit 50 charges/discharges the capacity unit 40, whereby the voltage value applied to the control terminal 10a of the resistance-variable switch 10 changes continuously from V₁ to V₂. The protection circuit 2 repeats this action until there is no short-circuiting. The control voltage application unit 30 may keep applying the control voltage V₂ to the voltage at the control terminal 10a after the overcurrent detection signal returns to the insignificant value. This can keep the current flowing between the first and second terminals 10b, 10c of the resistance-variable switch 10 at the predetermined threshold Iₜₕ or below.

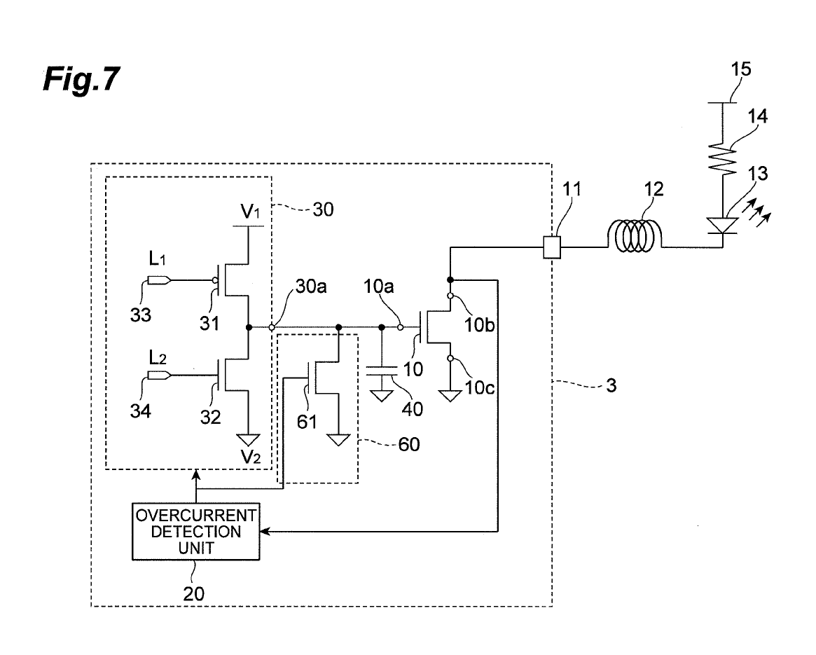

FIG. 7 is a diagram illustrating the structure of a protection circuit 3 of the second embodiment. The protection circuit 3 of the second embodiment illustrated in FIG. 7 differs from the structure of the protection circuit 2 of the first embodiment illustrated in FIG. 4 in that it comprises a control terminal voltage change unit 60 in place of the control terminal voltage change unit 50. The control terminal voltage change unit 60 includes a switch 61 provided between the control terminal 10a of the resistance-variable switch 10 and a reference potential terminal. The switch 61 has one terminal connected to the control terminal 10a of the resistance-variable switch 10 and the other terminal connected (grounded) to the reference potential terminal.

That is, in the protection circuit 3 of the second embodiment, the control terminal voltage change unit 60 includes the switch 61 provided between the control terminal 10a of the resistance-variable switch 10 and the reference potential terminal. A specific example of the switch 61 is an NMOS transistor, which is controlled by an overcurrent detection signal fed from the overcurrent detection unit 20. The control terminal voltage change unit 60 has a gate terminal connected to the overcurrent detection unit 20, a drain terminal connected to the control terminal 10a of the resistance-variable switch 10, and a source terminal connected (grounded) to the reference potential terminal. The switch 61 turns on when the overcurrent detection signal fed from the overcurrent detection unit 20 changes from an insignificant value to a significant value and off when the overcurrent detection signal is the insignificant value.

When the overcurrent detection signal fed from the overcurrent detection unit 20 changes from the insignificant value to the significant value in the protection circuit 3 of the second embodiment, the control voltage application unit 30 places the output terminal 30a into a high impedance state, while the control terminal voltage change unit 60 turns the switch 61 on. As a consequence, a current flows between the drain and source terminals of the switch 61. Its current value corresponds to the ON-resistance value of the switch 61. When the switch 61 is turned on, the capacity unit 40 is charged/discharged, so that the voltage value at the control terminal 10a of the resistance-variable switch 10 continuously changes from V₁ to V₂. This continuously increases the resistance value between the first and second terminals 10b, 10c, thereby continuously decreasing the current flowing therebetween. As a result, devices can more effectively be prevented from being destroyed. The change in voltage value from V₁ to V₂ occurs at a speed corresponding to the ON-resistance value of the switch 61 and the capacity value of the capacity unit 40. That is, as the ON-resistance value of the switch 61 is greater, the current value flowing between the drain and source terminals of the switch 61 becomes smaller, whereby the change in voltage value from V₁ to V₂ is effected slowly.

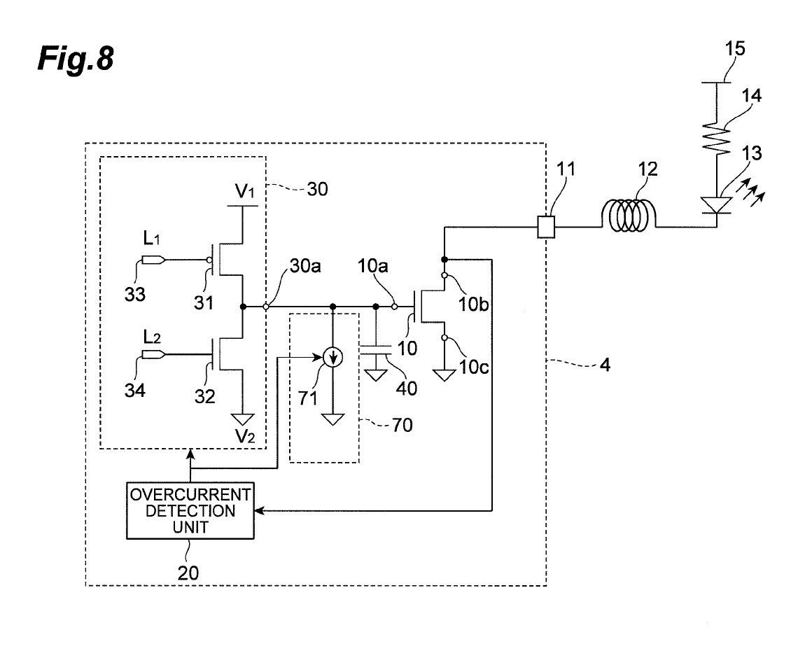

FIG. 8 is a diagram illustrating the structure of a protection circuit 4 of the third embodiment. The protection circuit 4 of the third embodiment illustrated in FIG. 8 differs from the structure of the protection circuit 2 of the first embodiment illustrated in FIG. 4 in that it comprises a control terminal voltage change unit 70 in place of the control terminal voltage change unit 50 in the protection circuit 2. The control terminal voltage change unit 70 includes a current source 71, which has one end connected to the control terminal 10a of the resistance-variable switch 10 and the other terminal connected (grounded) to a reference potential terminal.

The current source 71 generates a fixed current according to an overcurrent detection signal fed from the overcurrent detection unit 20. The current source 71 generates no current when the overcurrent detection signal fed from the overcurrent detection unit 20 is an insignificant value. When the overcurrent detection signal fed from the overcurrent detection unit 20 turns from the insignificant value to a significant value, on the other hand, the current source 71 generates the fixed current.

When the overcurrent detection signal fed from the overcurrent detection unit 20 turns from the insignificant value to the significant value in the protection circuit 4 of the third embodiment, the control voltage application unit 30 places the output terminal 30a into a high impedance state, while the control terminal voltage change unit 70 allows the fixed current to flow from the current source 71. When the fixed current flows from the current source 71, the capacity unit 40 is charged/discharged, so that the voltage value at the control terminal 10a of the resistance-variable switch 10 continuously changes from V₁ to V₂. This continuously increases the resistance value between the first and second terminals 10b, 10c, thereby continuously decreasing the current flowing therebetween. As a result, devices can more effectively be prevented from being destroyed. The change in voltage value from V₁ to V₂ occurs at a speed corresponding to the ON-resistance value of the current source 71 and the capacity value of the capacity unit 40.

The present invention can be modified in various ways without being restricted to the above-mentioned embodiments.

While the first, second, and third embodiments illustrate circuit structures in which the resistance-variable switch 10 is an NMOS transistor, the present invention is also applicable to circuit structures in which the resistance-variable switch 10 is a PMOS transistor. Bipolar transistors and the like may also be used for the resistance-variable switch 10. Both NPN and PNP bipolar transistors are employable as the bipolar transistors.

The structure of the control voltage application unit 30 is not limited to the above-mentioned embodiments. The control voltage application unit 30, which is constructed so as to include the PMOS transistor 31 and NMOS transistor 32 in the above-mentioned embodiments, may be constituted by the PMOS transistor 31 alone, for example.

The structure of the control terminal voltage change unit 50 is not limited to the above-mentioned embodiments as long as the voltage value applied to the control terminal 10a of the resistance-variable switch can be changed continuously from V₁ to V₂. For example, a PMOS transistor can be used as the switch 51 for the protection circuit 2.

Not only the LED 13, but other electric components can also be connected to the outer terminal 11. Even when the line 12 between the outer terminal 11 and an electric component is long and thus yields a large parasitic inductance, large counter-electromotive voltages V are hard to occur, so that the protection circuit 2 or resistance-variable switch 10 can effectively be prevented from being destroyed.

### INDUSTRIAL APPLICABILITY

The present invention can be employed in uses for more effectively inhibiting counter-electromotive voltages from occurring and preventing excessive voltages from destroying devices.

### REFERENCE SIGNS LIST

1, 2, 3, 4 protection circuit
10 resistance-variable switch
11 outer terminal
20 overcurrent detection unit
30 control voltage application unit
31 PMOS transistor
32 NMOS transistor
33 first input terminal
34 second input terminal
40 capacity unit
50 control terminal voltage change unit
51 switch
52 resistor
60 control terminal voltage change unit
61 switch
70 control terminal voltage change unit
71 current source

1. A protection circuit comprising:
a resistance-variable switch having a control terminal and first and second terminals, the first and second terminals yielding therebetween a resistance value continuously monotonously changing with respect to a control voltage applied to the control terminal within the range from V₁ to V₂, the resistance value being greater when the control voltage is V₂ than when V₁;
a capacity unit having one end connected to the control terminal of the resistance-variable switch;
an overcurrent detection unit for outputting an overcurrent detection signal turning from an insignificant value to a significant value when a current flowing between the first and second terminals of the resistance-variable switch is greater than a predetermined threshold;
a control voltage application unit for outputting and applying a control voltage value from an output end to the control terminal of the resistance-variable switch when the overcurrent detection signal is the insignificant value and placing the output terminal into a high impedance state when the overcurrent detection signal is the significant value; and
a control terminal voltage change unit for continuously changing the voltage value at the control terminal of the resistance-variable switch from V₁ to V₂ by discharging or charging the capacity unit when the overcurrent detection signal is the significant value.

2. A protection circuit according to claim 1, wherein the control terminal voltage change unit includes a switch and a resistor, the switch and resistor being provided in series between the control terminal of the resistance-variable switch and a reference potential terminal, the control terminal voltage change unit turning the switch on when the overcurrent detection signal is the significant value, so as to change the voltage value at the control terminal of the resistance-variable switch continuously at a speed corresponding to a resistance value of the resistor and a capacity value of the capacity unit.

3. A protection circuit according to claim 1, wherein the control terminal voltage change unit includes a switch provided between the control terminal of the resistance-variable switch and a reference potential terminal and turns the switch on when the overcurrent detection signal is the significant value, so as to change the voltage value at the control terminal of the resistance-variable switch continuously at a speed corresponding to an ON-resistance value of the switch and a capacity value of the capacity unit.

4. A protection circuit according to claim 1, wherein the control terminal voltage change unit includes a current source provided between the control terminal of the resistance-variable switch and a reference potential terminal and starts operating the current source when the overcurrent detection signal is the significant value, so as to change the voltage value at the control terminal of the resistance-variable switch continuously at a speed corresponding to a current value of the current source and a capacity value of the capacity unit.
